(19) United States
(12) Patent Application Publication
(10) Pub. No.: US 2024/0238766 A1
(43) Pub. Date: Jul. 18, 2024

(54) HYDROGEN OXIDATION CATALYST AND METHOD FOR PRODUCING SAME

(71) Applicant: HYDROCHEM, INC., Seoul (KR)

(72) Inventor: Soon Seop SHIM, Bucheon-si (KR)

(21) Appl. No.: 18/566,034

(22) PCT Filed: May 30, 2022
(86) PCT No.: PCT/KR2022/007621

§ 371 Date: Nov. 30, 2023

(30) Foreign Application Priority Data
Jun. 1, 2021 (KR) 10-2021-0070650

(51) Int. Cl. B01J 23/644; B01J 21/06; B01J 23/42; B01J 37/02; B01J 37/08

(52) U.S. Cl. CPC B01J 23/6445; B01J 21/063; B01J 23/42; B01J 37/0219; B01J 37/086

(57) ABSTRACT

The present invention provides a hydrogen oxidation catalyst including a titania support on which a platinum cluster is supported, wherein the platinum cluster includes Pt0, and the number of terrace crystal surfaces among the terrace, step, and kink crystal surfaces formed by the Pt0 is larger than the number of the step and kink crystal surfaces.

### TECHNICAL FIELD

The present invention relates to a hydrogen oxidation catalyst and a method of preparing the same, and more particularly, to a hydrogen oxidation catalyst capable of controlling hydrogen with low-concentration at an extremely low temperature as well as room temperature, and a method of preparing the same.

### BACKGROUND ART

Currently, as interest in hydrogen energy is increasing worldwide, major countries such as the United States, Japan, and Europe are working hard to develop hydrogen energy technology. In addition, safety studies on the leakage and explosiveness of hydrogen that may occur in the process of hydrogen energy are also being conducted at the same time through steady investment. In the case of hydrogen, when the concentration is 4 vol % or more, hydrogen may be spontaneously ignited according to an ambient atmosphere to cause an explosion, and thus, safety problems with hydrogen occurring in various fields such as a fuel cell, a lead storage battery, a semiconductor process, and the like, have been mentioned.

Currently, research on hydrogen energy stability is mainly on hydrogen storage and blocking, leakage prevention sensors, etc., and recently, hydrogen removal technology is being studied. Typical hydrogen removal technologies include an igniter, a thermal recombiner, or a catalytic oxidation method to prevent damage from hydrogen explosion. Among them, the igniter and the thermal recombiner are a method of controlling hydrogen by injecting thermal energy up to a reaction temperature at which hydrogen can be recombined into water, which has disadvantages in that space use is limited and a separate energy source is required.

On the other hand, the catalytic oxidation technology is a technology that removes hydrogen by combining oxygen in a gas phase and hydrogen using a catalyst, and is a technology that can safely control hydrogen. Therefore, among the above-described three methods, a catalytic oxidation technique for combining hydrogen and oxygen using a catalyst is in the spotlight.

The catalytic oxidation technology recovers heat generated by an exothermic reaction of hydrogen and oxygen without a separate energy source to be applied to heating or hot water, or can be used as heat energy required for a system, thereby having an advantage in terms of energy efficiency. Moreover, the present invention has an advantage of being able to continuously process hydrogen generated in an enclosed space by using a natural convection phenomenon by heat generated when the hydrogen is processed.

In this regard, Korean Patent No. 10-0998325 discloses a method of preparing a catalyst for oxidizing formaldehyde at room temperature using a platinum/titania catalyst, Korean Patent No. 10-1660014 discloses a platinum/titania catalyst capable of removing hydrogen at room temperature, and Korean Patent No. 10-1331391 discloses a palladium/titania catalyst, not a platinum/titania catalyst, and a method of preparing the same.

As described above, the prior art discloses a catalyst capable of removing hydrogen at room temperature, but a catalyst capable of removing hydrogen at a low concentration at an extremely low temperature has not been disclosed.

### DISCLOSURE

### Technical Problem

The present invention has been made in an effort to provide a hydrogen oxidation catalyst capable of removing hydrogen at an extremely low temperature as well as room temperature.

### Technical Solution

In order to solve the above problem, the present invention provides a hydrogen oxidation catalyst including a titania support on which a platinum cluster is supported, wherein the platinum cluster includes Pt0, the Pt0 includes a terrace, step, and kink crystal surfaces, and the terrace crystal surface among the crystal surfaces is larger than the step and kink crystal surfaces.

In an exemplary embodiment of the present invention, an oxidation rate (Pt0/Pttotal) of the platinum cluster may be 40% to 50%.

As an exemplary embodiment of the present invention, the hydrogen oxidation catalyst may have a hydrogen oxidation reaction activity at a temperature in a range from a cryogenic temperature (−10° C.) to a room temperature (25° C.).

As an embodiment of the present invention, at least one co-catalyst of palladium and antimony may be further supported on the titania support.

In an exemplary embodiment of the present invention, the hydrogen oxidation catalyst may have a hydrogen oxidation activity of 95% or more even under a condition in which nitrogen oxides are simultaneously injected.

According to an embodiment of the present invention, the hydrogen oxidation catalyst may have a hydrogen oxidation activity of 80% or more even under a condition in which carbon monoxide is simultaneously injected.

According to another aspect of the present invention, there is provided a method of preparing a hydrogen oxidation catalyst, the method including: supporting a platinum cluster precursor on a titania support; and calcinating the supported platinum cluster/titania at 200˜300° C., wherein the platinum cluster includes Pt0, the Pt0 includes a terrace, a step, and a kink crystal surface, and in the calcinating temperature range, the terrace crystal surface among the crystal surfaces is larger than the step and the kink crystal surface.

In an embodiment of the present invention, the platinum cluster precursor may be 0.5 parts by weight or more based on 100 parts by weight of the titania support. In an exemplary embodiment of the present invention, the platinum cluster precursor may be any one of Ptc(MA), Ptc(EN), and Ptc(EA).

In an exemplary embodiment of the present invention, the oxidation rate (Pt0/Pttotal) of the platinum cluster to be reduced in the calcination step may be 40 to 50%.

In an exemplary embodiment of the present invention, the method may further include, before the platinum cluster precursor is supported on the titania support, supporting a co-catalyst precursor including at least one of palladium and antimony on the titania support.

According to an embodiment of the present invention, the cocatalyst precursor may be present in an amount of 0.1 to 2.0 parts by weight, based on 100 parts by weight of the titania support.

### Advantageous Effects

The hydrogen oxidation catalyst according to the present invention can effectively control low-concentration hydrogen at an extremely low temperature as well as room temperature.

In addition, the oxidation of Pt0 can exhibit species by only the calcination process without a reduction process of the hydrogen oxidation catalyst, thereby reducing time and costs in the preparing process.

### BRIEF DESCRIPTION OF DRAWINGS

FIG. 1 is a diagram illustrating a reaction crystal surface of Pt0.

FIGS. 2 and 3 are diagrams showing hydrogen oxidation reaction activity according to a hydrogen concentration and a reaction temperature of each Pt precursor, respectively.

FIG. 4 is a result of FT-IR analysis showing adsorption properties for each Pt precursor.

FIG. 5 is a diagram showing a hydrogen reaction activity according to a calcination temperature.

FIG. 6 shows FT-IR analysis results showing adsorption characteristics according to a calcination temperature.

FIG. 7 is a diagram showing a hydrogen oxidation activity according to a Ptc content.

FIGS. 8 and 9 are diagrams showing hydrogen reaction activity according to the addition of a cocatalyst, respectively.

FIGS. 10 and 11, respectively, showing hydrogen reaction activity according to the content of the co-catalyst added

FIG. 12, FIG. 13, and FIG. 14 show hydrogen reaction activity when carbon monoxide of different concentrations is simultaneously introduced with hydrogen.

FIG. 15, FIG. 16, and FIG. 17 show hydrogen reaction activity when nitrogen oxides of different concentrations are simultaneously introduced with hydrogen.

FIG. 18 is a diagram showing hydrogen reaction activity at each reaction temperature according to the addition of a co-catalyst.

FIG. 19 is a diagram showing selective reaction activity for hydrogen and carbon monoxide.

### BEST MODE

The present invention can apply various transformations and have various embodiments, and specific embodiments will be illustrated in the drawings and described in detail in the detailed description. However, this is not intended to limit the present invention to the specific embodiments, and it should be understood that the present invention includes all modifications, equivalents, and replacements included within the spirit and technical scope of the present invention. In describing the present invention, when it is determined that the detailed description of the related known technology may obscure the gist of the present invention, the detailed description thereof will be omitted.

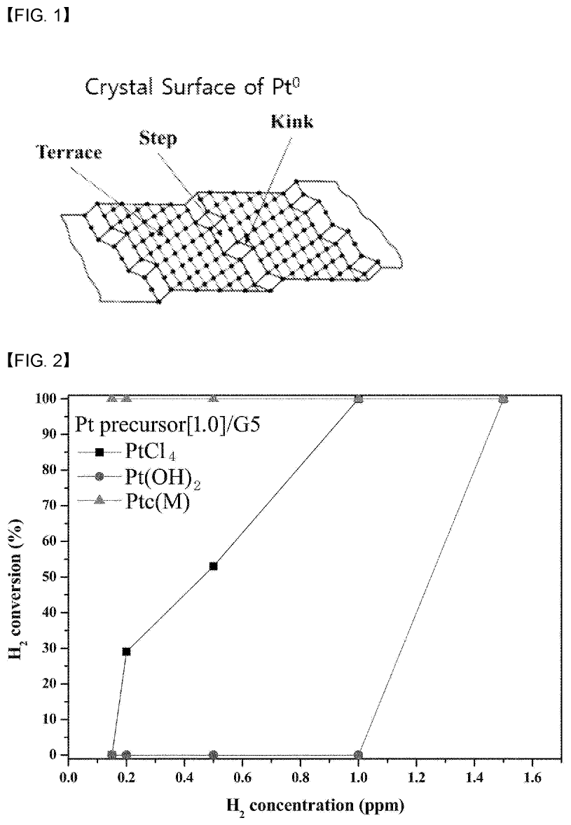

FIG. 1 is a diagram illustrating a reaction crystal surface of Pt0.

Referring to FIG. 1, Pt0 has a stepwise crystal structure in which three reaction crystal surfaces are formed as atoms are arranged and grown, and when the stepwise crystal structure is observed in three dimensions, a flat plane viewed as a plane corresponds to a terrace plane, an edge plane positioned between the terrace plane and viewed as a staircase corresponds to a step plane, and a vertex plane in which the step plane is cut or bent corresponds to a kink plane. At this time, the step and kink surfaces have very high degree of activation, so dissociation and adsorption are easy, whereas the terrace surfaces have weak degree of activation, so that they are adsorbed on molecules as they are rather than dissociated and adsorbed. Further, as a result of Fourier transform-infrared (FT-IR) analysis, the reaction crystal surfaces may be defined such that the terrace plane has 2075 to 2100 wave number (cm−1), the step plane has 2050 to 2075 wave number (cm−1), and the kink plane has 2000 to 2050 wave number (cm−1). The three reaction crystal surfaces exhibit different adsorption properties due to different arrangement methods of atoms, and thus the activity of the hydrogen oxidation reaction varies depending on the growth degree of each reaction crystal surface, which will be described in detail in the following Experimental Example.

As used herein, the term “Pt cluster (Ptc)” refers to a platinum structure including Pt0 that remains after being supported on a catalyst support and calcinated, and refers to all platinum structures in which a terrace surface predominates among reaction crystal surfaces of Pt0. In this case, it is clear that the reaction crystal surface related to the hydrogen oxidation reaction is a reaction crystal surface of Pt0, not the entire Pt representing various oxidation values.

Further, in the present specification, “the terrace surface of Pt0 predominately exists” means that the growth of the terrace surface among the reaction crystal surfaces of Pt0 is maximized, and thus the terrace surface is larger than the step surface and the kink surface, and thus the specific gravity of the terrace surface to which hydrogen is adsorbed as the reaction crystal surface during a hydrogen oxidation reaction is higher than the total specific gravity of the step surface and the kink surface.

The present invention provides a hydrogen oxidation catalyst including a titania support in which a platinum cluster is supported to remove low-concentration hydrogen at a very low temperature as well as at room temperature, wherein the platinum cluster includes Pt0, the Pt0 includes a terrace, a step, and a kink crystal surface, and the terrace crystal surface among the crystal surfaces is larger than the step and the kink crystal surface.

In particular, unlike the conventional technology in which hydrogen can be removed only at room temperature using PtCl4 and Pt(OH)2 as platinum precursors, the present invention uses a hydrogen oxidation catalyst containing platinum clusters to remove hydrogen at a very low temperature (−10° C.) as well as at room temperature (25° C.), and the effect of removing hydrogen at room temperature and at a very low temperature according to the use of platinum clusters will be described in detail in the following experimental example.

In the platinum cluster corresponding to the active metal, Pt0 or Pt2+ oxidation may appear as a species on the surface of the hydrogen oxidation catalyst, and Pt0 is a major factor in the hydrogen oxidation reaction activity. In an exemplary embodiment of the present invention, the oxidation rate (Pt0/Pttotal) of the platinum cluster may be 40 to 50%.

As described above, Pt0 forms different reaction crystal surfaces of a terrace, a step, and a kink according to the arrangement of atoms, and has different adsorption properties due to different arrangement methods of atoms according to the crystal surfaces. In the case of the related art in which Pt(OH)2 is used as a platinum precursor, hydrogen adsorption properties are exhibited only at room temperature, and in this case, Step and Kink planes are dominant in a crystal surface of Pt0, and particularly, a Step plane has a high specific gravity. Unlike this, the present invention using the platinum cluster shows low-concentration hydrogen adsorption properties at a very low temperature as well as room temperature, and in this case, the Terrace plane is predominately shown in the crystal surface of Pt0. That is, when there are more Terrace planes of Pt0 than Step and Kink planes during hydrogen adsorption, low-concentration hydrogen may be controlled at an extremely low temperature as well as at room temperature.

At least one co-catalyst of palladium and antimony may be further supported on the titania support, and hydrogen oxidation activity at an extremely low temperature may be improved by the addition of the co-catalyst, and poisoning resistance due to the simultaneous introduction of carbon monoxide and nitrogen oxide may be increased. Such an effect will be described in detail in an experimental example to be described later.

In addition, the present invention provides a method for preparing a hydrogen oxidation catalyst, comprising the steps of: supporting a platinum cluster precursor on a titania support; and calcinating the titania support on which the platinum cluster precursor is supported.

The platinum cluster precursor may be any one of Ptc(MA), Ptc(EN), and Ptc(EA), but Ptc(MA) is preferred in consideration of the high specific surface area and the size of active particles. In the Ptc(MA), Ptc(EN), and Ptc(EA), MA is methyl alcohol, EN is nitric acid, and EA is ethyl alcohol, and means a platinum cluster precursor prepared by each material treatment.

The platinum cluster precursor may be supported in an amount of 0.5 parts by weight or more based on 100 parts by weight of the titania support, and within this range, hydrogen of a low concentration present at an extremely low temperature as well as room temperature may be removed.

In particular, in the present invention, the oxidation of Pt0 may represent species through the calcination step the titania support on which the platinum cluster precursor is supported. When a hydrogen oxidation catalyst is prepared by using PtCl4 and Pt(OH)2 as a platinum precursor according to the related art, a reduction process should be necessarily performed after the catalyst is deactivated in order to exhibit species of Pt0. On the other hand, according to the present invention, by using the platinum cluster precursor, the oxidation of Pt0 can show species through only the calcination process, thereby reducing costs and time in the preparing process.

The oxidation rate (Pt0/Pttotal) of the platinum cluster precursor to be reduced in the calcination step may be 40 to 50%, and in the above range, hydrogen of a low concentration may be controlled at an extremely low temperature as well as room temperature.

The calcination temperature in the calcination step is preferably 200˜300° C., and the oxidation of Pt0 in the above range may be maintained in the above ratio range of the paper, and the Terrace plane is predominately shown to control the low concentration of hydrogen at an extremely low temperature. When the catalyst is out of the above-described range, the specific surface area of the catalyst is significantly reduced and the growth of Pt2+ is maximized, such that the ratio of Pt0 is lowered, and Step and Kink planes of Pt0 are grown, such that the specific gravity of the Terrace plane is decreased, such that hydrogen oxidation activity of a low concentration at an extremely low temperature is lowered.

In an exemplary embodiment of the present invention, the method may further include supporting a co-catalyst precursor including at least one of palladium and antimony on the titania support before the platinum cluster precursor is supported on the titania support.

The co-catalyst precursor may improve hydrogen oxidation activity at extremely low temperatures, increase toxicity due to the simultaneous inflow of carbon monoxide and nitrogen oxide, and be supported in an amount of 0.1 to 2.0 parts by weight based on 100 parts by weight of the titania support.

Hereinafter, the present invention will be described in more detail based on preferred experimental examples of the present invention. However, the technical spirit of the present invention is not limited thereto and may be modified by skilled person in the art to be variously implemented.

### DETAILED DESCRIPTION OF THE INVENTION

### Experimental Example 1: Comparison of Hydrogen Reaction Activity

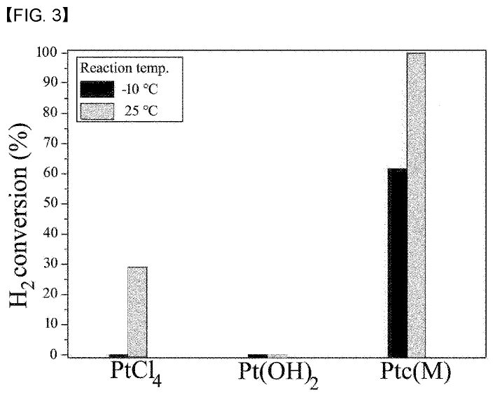

FIGS. 2 and 3 are diagrams showing hydrogen oxidation reaction activity according to a hydrogen concentration and a reaction temperature of each Pt precursor, respectively.

Referring to FIG. 2, it can be seen that the hydrogen oxidation reaction activity of the catalyst prepared from Ptc(MA) was maintained at 100% even in low-concentration hydrogen, whereas the hydrogen oxidation reaction activity of the catalyst prepared from PtCl4 and Pt(OH)2 was significantly reduced in low-concentration hydrogen.

In addition, referring to FIG. 3, it can be seen that the hydrogen oxidation reaction activity of the catalyst prepared from Ptc(MA) was maintained high not only at room temperature (25° C.) but also at a very low temperature (−10° C.), whereas the hydrogen oxidation reaction activity of the catalyst prepared from PtCl4, Pt(OH)2 was almost not exhibited at a very low temperature.

That is, the hydrogen oxidation catalyst according to the present invention is expected to control low-concentration hydrogen at an extremely low temperature as well as room temperature.

### Experimental Example 2: Comparison of the Oxidation State and Physical Properties of Each Pt Precursor

Table 1 shows the oxidation state and physical characteristics of each Pt precursor.

TABLE 1

| Pt | Pt0/(Pt0 + | Pt2+/(Pt0 + | Oα/(Oα + | Oβ/(Oα + | BET | Active particle |
|---|---|---|---|---|---|---|
| precursor | Pt2+)(%) | Pt2+)(%) | Oβ) (%) | Oβ) (%) | (m2/g) | diameter (nm) |
| PtCl4 | 83.09 | 16.1 | 10.71 | 99.29 | 41.07 | 2.87 |
| Pt(OH)2 | 53.11 | 46.89 | 9.99 | 90.01 | 50.64 | 2.44 |
| Ptc(MA) | 42.92 | 57.08 | 12.74 | 87.25 | 184.19 | 4.85 |

Referring to Table 1, the specific surface area of Ptc(MA) was about 4.5 times higher than that of PtCl4, about 3.6 times higher than that of Pt(OH)2, the size of the reaction particles was 4.85 nm, and the ratio of the lattice oxygen (ou) was also high. Therefore, with regard to Experimental Example 1, it is judged that the excellent characteristics contribute to high hydrogen oxidation reaction activity of the catalyst supported with the platinum cluster according to the present invention.

### Experimental Example 3: Comparison of Adsorption Properties for Pt Precursors

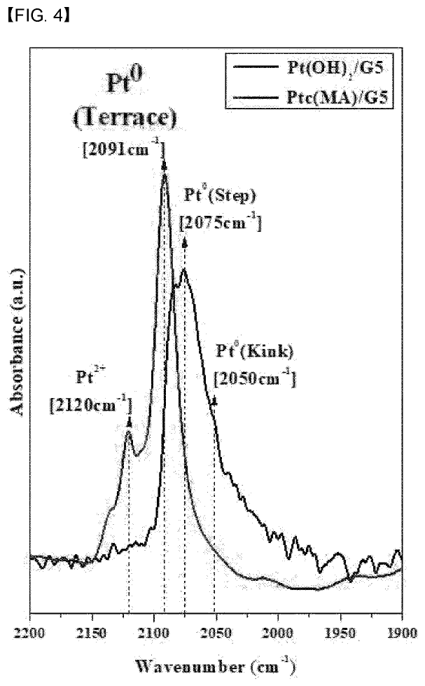

FIG. 4 is a FT-IR analysis result showing adsorption characteristics of each Pt precursor, and Table 2 is a table showing the FT-IR analysis result.

TABLE 2

| Pt site | Kink | Step | Terrace |
|---|---|---|---|
| FT-IR | 2000~2050 | 2050~2075 | 2075~2100 |
| wavenumber(cm−1) | | | |
| Pt(OH)2[1.0]/G5 | 6.7 | 59.9 | 33.4 |
| Ptc(MA)[1.0]/G5 | 2.83 | 11.7 | 85.2 |

Referring to FIG. 4 and Table 2, it can be confirmed that Ptc(MA) is actively adsorbed on the terrace surface due to the growth of the terrace surface of Pt0, whereas Pt(OH)2 is actively adsorbed on the step surface and the kink surface of Pt0, mainly on the step surface. That is, in the hydrogen oxidation catalyst according to the present invention, the terrace surface of Pt0 predominately appears, and hydrogen adsorption is actively generated on the terrace surface, and it is judged that low-concentration hydrogen control may be performed at an extremely low temperature as well as at room temperature.

### Experimental Example 4: Comparison of Hydrogen Reaction Activity, Physical Properties, and Oxidation Value State According to Firing Temperature

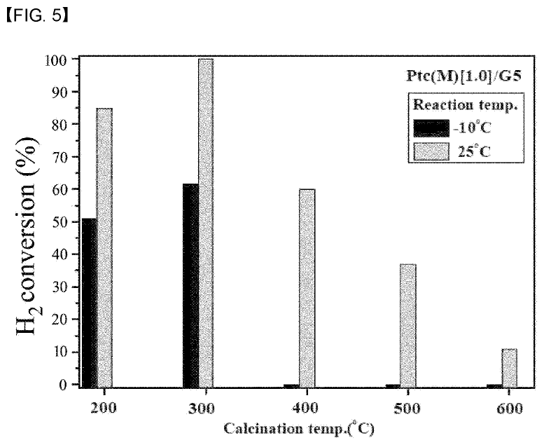

FIG. 5 and Table 3 show the hydrogen reaction activity, physical properties, and oxidation state according to the firing temperature of the present invention, respectively.

TABLE 3

| Calcination | | | | |
|---|---|---|---|---|
| temp.(° C.) | Pt0/ | Pt2+/ | BET | Active particle |
| (xCal. −4 hr) | (Pt0+ Pt2+) | (Pt0+ Pt2+) | (m2/g) | diameter(nm) |
| 200 | 46.01 | 53.99 | 251.47 | 3.33 |
| 300 | 42.92 | 57.08 | 184.19 | 4.85 |
| 400 | 40.72 | 59.28 | 121.72 | 8.19 |
| 500 | 29.04 | 70.96 | 87.809 | 10.7 |
| 600 | 12.17 | 87.83 | 47.672 | 21.3 |

Referring to FIG. 5 and Table 3, it was confirmed that the ratio of Pt0 and the specific surface area were high and the size of the reaction particles was small when the calcination was performed at 200° C. and 300° C., but the specific surface area was remarkably reduced and the size of the reaction particles was large when the calcination was performed at a temperature higher than 300° C. Above all, it could be confirmed that when the reaction mixture was calcined at 200° C. and 300° C., the reaction mixture exhibited high hydrogen reaction activity at a cryogenic temperature (−10° C.) as well as at room temperature, but when the reaction mixture was calcined at a temperature higher than 300° C., the reaction mixture gradually decreased at room temperature, and the reaction mixture showed almost no hydrogen reaction activity at the cryogenic temperature (−10° C.). Through this, it is determined that the hydrogen oxidation catalyst supported with the platinum cluster of the present invention is calcinated in the range of 200 to 300° C. to have high hydrogen control performance of a low concentration at an extremely low temperature as well as room temperature.

### Experimental Example 5: Comparison of Adsorption Characteristics According to Calcination Temperature

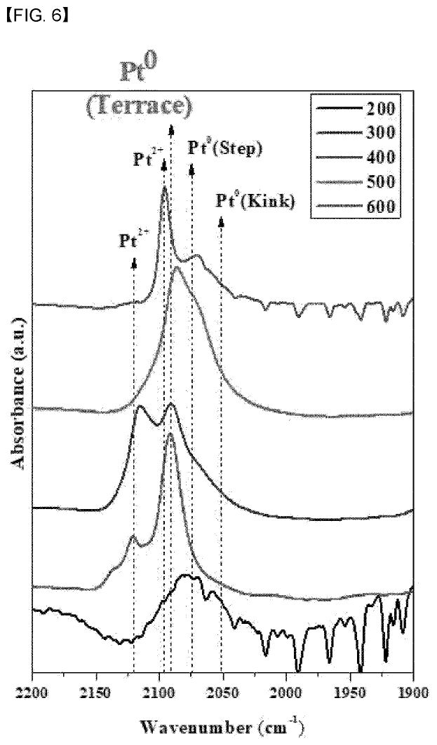

FIG. 6 shows FT-IR analysis results showing adsorption characteristics according to the calcination temperature of the present invention, and Table 4 shows FT-IR analysis results.

TABLE 4

| Calcination | | | |
|---|---|---|---|
| temperature | Kink | Step | Terrace |
| FT-IR | 2000~2050 | 2050~2075 | 2075~2100 |
| wavenumber(cm−1) | | | |
| 200 | 4.61 | 37.1 | 58.29 |
| 300 | 2.83 | 11.7 | 85.2 |
| 400 | 8.1 | 20.1 | 71.8 |
| 500 | 9.7 | 26.1 | 64.2 |
| 600 | 12.7 | 57.2 | 31.1 |

Referring to FIG. 6 and Table 4, in the present invention, the terrace surface of Pt0 was predominately shown, and particularly, when the Pt0 was calcinated at 300° C., the specific gravity of the terrace surface was the highest at 85.2%, but when the Pt0 was calcinated at a temperature higher than 300° C., the specific gravity of the terrace surface was reduced. Therefore, when the hydrogen oxidation catalyst carrying a platinum cluster is calcinated at 300° C., the growth of the terrace surface is promoted, and it is judged that the hydrogen control performance of a low concentration at an extremely low temperature as well as room temperature is excellent.

### Experimental Example 6: Comparison of Hydrogen Oxidation Activity by Ptc Content

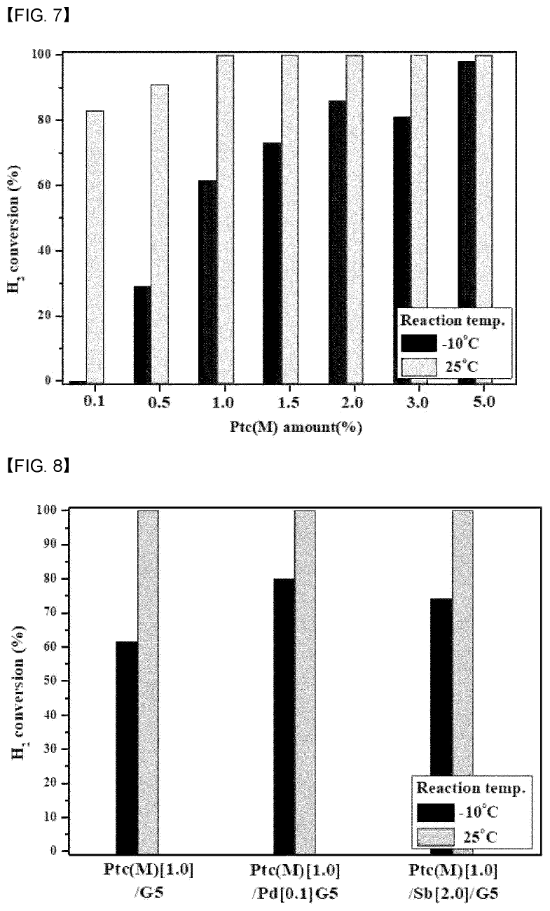

FIG. 7 is a diagram showing a hydrogen oxidation activity according to a Ptc content of the present invention.

Referring to FIG. 7, it was confirmed that as the Ptc content increased, the hydrogen oxidation activity at the cryogenic temperature (−10° C.) increased, and the minimum content of Ptc for exhibiting the hydrogen oxidation activity at the cryogenic temperature was 0.1%. That is, it could be confirmed that the content of Ptc should be 0.1 parts by weight or more based on 100 parts by weight of the titania support in order to control the hydrogen of low concentration at an extremely low temperature.

### Experimental Example 7: Comparison of Hydrogen Reaction Activity According to the Addition of a Cocatalyst

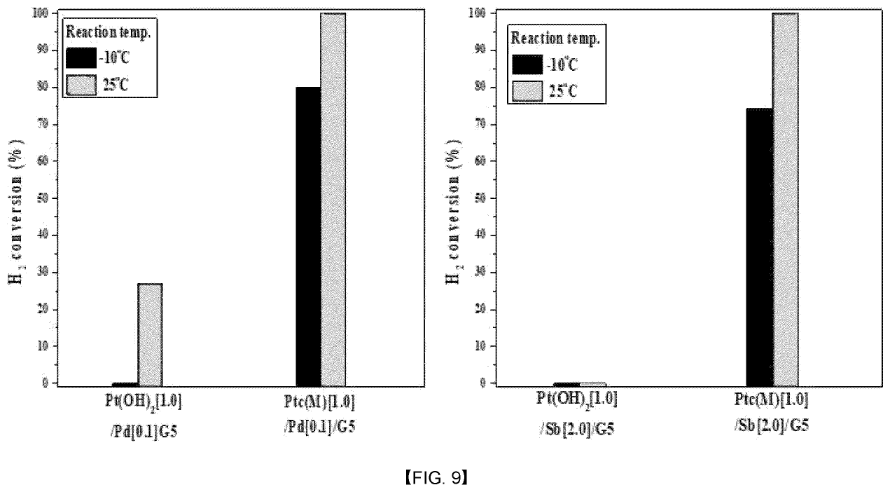

FIGS. 8 and 9 are diagrams showing hydrogen reaction activity according to the addition of a cocatalyst, respectively.

Referring to FIG. 8, when Pd and Sb were added as the co-catalyst, the hydrogen reaction activity was high at a very low temperature (−10° C.), and when the co-catalyst was not added, the hydrogen reaction activity was slightly low at the very low temperature. In addition, referring to FIG. 9, in the case of Ptc(MA) and Pt(OH)2 to which the co-catalyst is added in the same manner, it was found that the difference in hydrogen reaction activity at the very low temperature is very large. Through this, it was confirmed that the hydrogen reaction activity at a low concentration at a cryogenic temperature (−10° C.) can be improved by adding the co-catalyst of Pd or Sb to the hydrogen oxidation catalyst supported with the platinum cluster of the present invention.

### Experimental Example 8: Comparison of Hydrogen Reaction Activity According to Cocatalyst Content

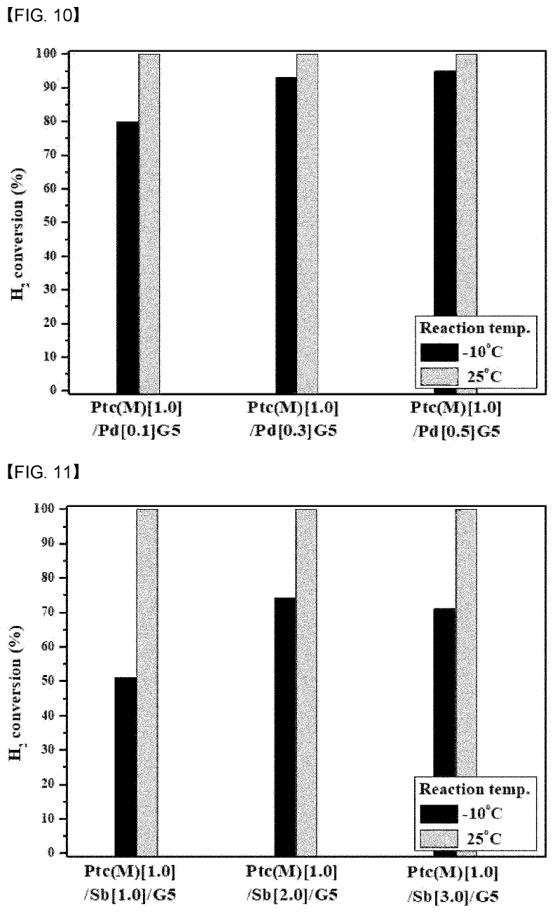

FIGS. 10 and 11 are diagrams showing hydrogen reaction activity according to the content of Pd and Sb added, respectively.

Referring to FIGS. 10 and 11, as the Pd content was increased from 0.1 to 0.5, the low-concentration hydrogen reaction activity at the cryogenic temperature (−10° C.) was improved, and as the Sb content was increased from 1.0 to 2.0, the low-concentration hydrogen reaction activity at the cryogenic temperature was improved, but when the Sb content was more than 2.0, the hydrogen reaction activity was slightly reduced. Accordingly, it was confirmed that the co-catalyst was added in an amount of 0.1 to 2.0 parts by weight based on 100 parts by weight of the titania support to exhibit excellent low-concentration hydrogen reaction activity at an extremely low temperature.

### Experimental Example 9: Comparison of Carbon Monoxide Endothelial Toxicity According to Addition of Cocatalyst

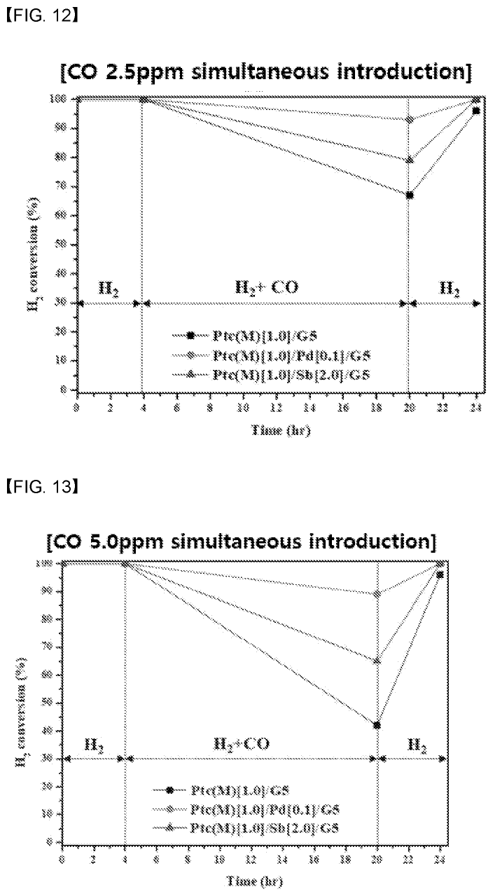

FIG. 12, FIG. 13, and FIG. 14 show hydrogen reaction activity when carbon monoxide of different concentrations is simultaneously introduced with hydrogen.

Referring to FIGS. 12 and 13, when carbon monoxide having a concentration of 2.5 ppm or 5.0 ppm is simultaneously introduced with hydrogen at a reaction temperature of −10° C. to 25° C., when Pd or Sb is added as a co-catalyst, it is confirmed that the hydrogen reaction activity is higher than that when no co-catalyst is added, and particularly, when pd is added as a co-catalyst, it is confirmed that the hydrogen reaction activity is maintained in a high state because the carbon monoxide has high endothelial toxicity.

In addition, referring to FIG. 14, when carbon monoxide of 5.0 ppm is simultaneously introduced with hydrogen at a reaction temperature of 50° C., when Pd is added as a co-catalyst, it has a hydrogen reaction activity of close to 100% and thus carbon monoxide poisoning is very high, but Pt(OH)2 has a very low carbon monoxide poisoning resistance due to a rapid decrease in hydrogen reaction activity.

### Experimental Example 10: Comparison of Nitrogen Oxide Endothelial Toxicity According to the Addition of a Cocatalyst

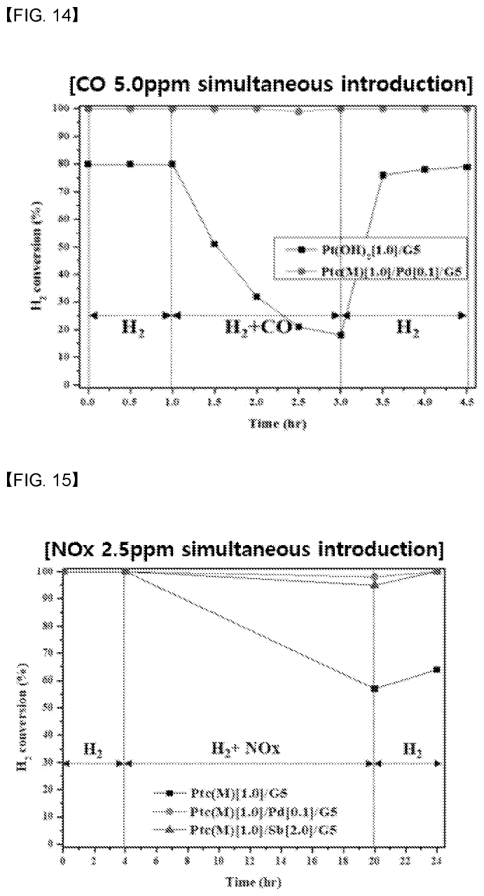

FIG. 15, FIG. 16, and FIG. 17 show hydrogen reaction activity when nitrogen oxides of different concentrations are simultaneously introduced with hydrogen.

Referring to FIGS. 15 and 16, it can be seen that when nitrogen oxide having a concentration of 2.5 ppm or 5.0 ppm is simultaneously introduced with hydrogen at a reaction temperature of −10° C. to 25° C., when Pd or Sb is added as a co-catalyst, the nitrogen oxide has a poisoning resistance, and thus the hydrogen reaction activity is higher than that when no co-catalyst is added, and particularly, when pd is added as a co-catalyst, the nitrogen oxide has a high poisoning resistance, and thus the hydrogen reaction activity is maintained in a high state. In addition, compared with Experimental Example 9, it was confirmed that the increase in endothelial toxicity due to the addition of the cocatalyst was larger for the nitrogen oxide than for the carbon monoxide.

In addition, referring to FIG. 17, when nitrogen oxides of 5.0 ppm are simultaneously introduced with hydrogen at a reaction temperature of 50° C., when Pd is added as a co-catalyst, the reaction activity of hydrogen is close to 100%, and thus the nitrogen oxide endothelial toxicity is very high, but the activity of hydrogen reaction of Pt(OH)2 is rapidly decreased, and thus the nitrogen oxide endothelial toxicity is very low.

### Experimental Example 11: Comparison of Hydrogen Reaction Activity at Each Reaction Temperature According to the Addition of a Cocatalyst

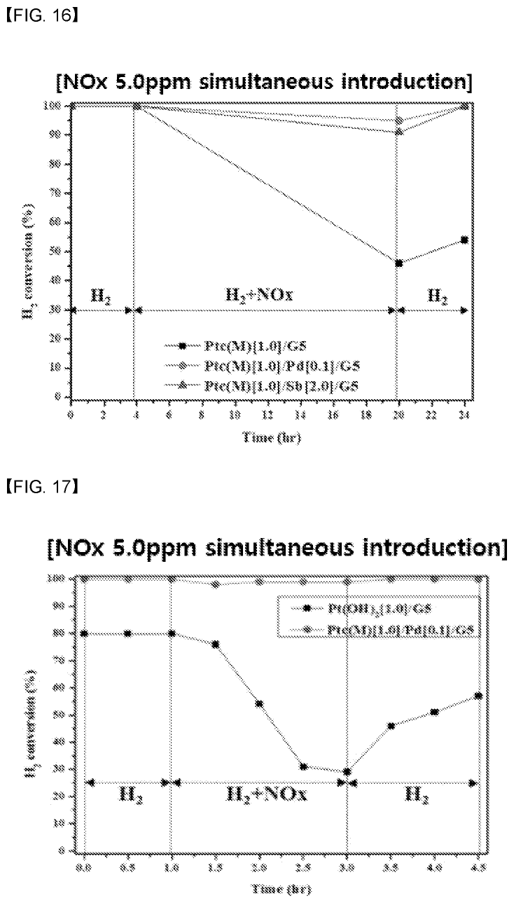

FIG. 18 is a diagram showing hydrogen reaction activity at each reaction temperature according to the addition of a co-catalyst.

Referring to FIG. 18, it was confirmed that Pt(OH)2, to which no co-catalyst was added, exhibited hydrogen reaction activity only at 50° C., particularly, little hydrogen reaction activity at a very low temperature (−10° C.), whereas Ptc(MA), to which Pd was added as a co-catalyst, exhibited high hydrogen reaction activity in a wide temperature range of −10 to 50° C.

### Experimental Example 12: Comparison of Selective Reaction Activity of Hydrogen and Carbon Monoxide

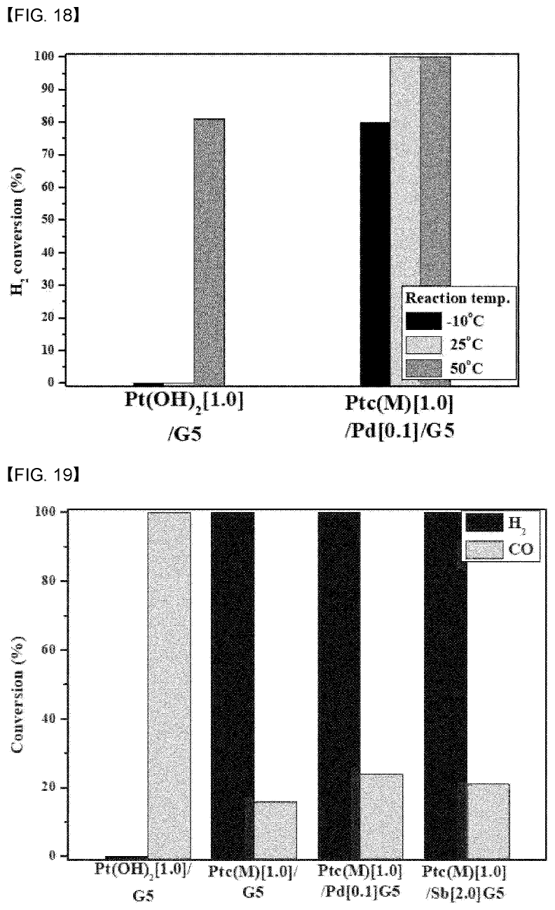

FIG. 19 is a diagram showing selective reaction activity for hydrogen and carbon monoxide.

Referring to FIG. 19, in the case of Ptc or Ptc to which a cocatalyst is added according to the present invention, it can be confirmed that the reaction activity of hydrogen is high even in a situation in which hydrogen and carbon monoxide coexist, and thus, the selective control of hydrogen is possible, whereas Pt(OH)2 shows only the reaction activity of carbon monoxide, and thus, it is difficult to control hydrogen.

1. A hydrogen oxidation catalyst including a titania support on which a platinum cluster is supported, wherein the platinum cluster includes Pt0, the Pt0 includes a terrace, a step, and a kink crystal surface, and, among the crystal surfaces, the terrace crystal surfaces are more than the step and the kink crystal surfaces.

2. The hydrogen oxidation catalyst of claim 1, wherein the platinum cluster has an oxidation rate (Pt0/Ptotal) of 40 to 50%.

3. The hydrogen oxidation catalyst of claim 1, wherein the hydrogen oxidation catalyst has a hydrogen oxidation reaction activity at a temperature in the range of from about −10° C. to about 25° C.

4. The hydrogen oxidation catalyst of claim 1, wherein the titania support is further supported by at least one co-catalyst of palladium and antimony.

5. The hydrogen oxidation catalyst of claim 4, wherein the hydrogen oxidation catalyst has a hydrogen oxidation activity of 95% or more even under a condition in which nitrogen oxides are simultaneously injected.

6. The hydrogen oxidation catalyst of claim 4, wherein the hydrogen oxidation catalyst has a hydrogen oxidation activity of 80% or more even under a condition in which carbon monoxide is simultaneously injected.

7. A method for preparing a hydrogen oxidation catalyst, the method comprising: supporting a platinum cluster precursor on a titania support; and calcinating the supported platinum cluster/titania at 200˜300° C., wherein the platinum cluster includes Pt0, the Pt0 includes a terrace, a step, and a kink crystal surface, and in the calcination temperature range, the terrace crystal surface of the crystal surface is more than the step and the kink crystal side.

8. The method for preparing a hydrogen oxidation catalyst of claim 7, wherein the platinum cluster precursor is 0.5 parts by weight or more based on 100 parts by weight of the titania support.

9. The method for preparing a hydrogen oxidation catalyst of claim 8, wherein the platinum cluster precursor is any one of Ptc(MA), Ptc(EN), and Ptc(EA).

10. The method for preparing a hydrogen oxidation catalyst of claim 7, wherein the platinum cluster to be reduced in the Calcination step has an oxidation ratio (Pt0/Pttotal) of 40 to 50%.

11. The method for preparing a hydrogen oxidation catalyst of claim 7, further comprising, before the platinum cluster precursor is supported on the titania support, supporting a co-catalyst precursor comprising at least one of palladium and antimony on the titania support.

12. The method for preparing a hydrogen oxidation catalyst of claim 11, wherein the cocatalyst precursor is used in an amount of 0.1 to 2.0 parts by weight based on 100 parts by weight of the titania support.
